(19) United States
(12) Patent Application Publication
(10) Pub. No.: US 2019/0208168 A1
(43) Pub. Date: Jul. 4, 2019

(54) Limited Access Community Surveillance System

(71) Applicant: John K. Collings, III, Mableton, GA (US)

(72) Inventor: John K. Collings, III, Mableton, GA (US)

(21) Appl. No.: 16/299,514

(22) Filed: Mar. 12, 2019

Related U.S. Application Data
(63) Continuation-in-part of application No. 15/416,676, filed on Jan. 26, 2017.
(60) Provisional application No. 62/641,560, filed on Mar. 12, 2018.
(60) Provisional application No. 62/288,670, filed on Jan. 29, 2016.

(51) Int. Cl. H04N 7/18; G06K 9/00

(52) U.S. Cl. CPC H04N 7/181; H04N 7/188; G06K 9/00771

(57) ABSTRACT

A surveillance system includes at least one controllable first video camera (422) that has a field of vision (408). A geographically-aware event indicating device (426) has a known spatial relationship to the first video camera (422). A processor (110) is in communication with the first video camera (422) and the geographically-aware event indicating device (426). The processor (110) is programmed to aim the first video camera (422) along in a direction indicated by the geographically-aware event indicating device (426) when the geographically-aware event indicating device (426) indicates an event that is consistent with predetermined criteria. A computer readable memory (112) is in communication with the processor (110) and stores video data from the first video camera (422) and sound data from the first acoustic sensor.

### CROSS-REFERENCE TO RELATED APPLICATIONS

This application is a continuation-in-part of and claims the benefit of U.S. patent application Ser. No. 15/416,676, filed on Jan. 26, 2017, which is non-provisional application claiming the benefit of 62/288,670, filed Jan. 29, 2016. This application also claims the benefit of U.S. Provisional Patent Application Ser. No. 62/641,560, filed Mar. 12, 2018, the entirety of each of which is hereby incorporated herein by reference.

### BACKGROUND OF THE INVENTION

### 1. Field of the Invention

The present invention relates to surveillance systems and, more specifically, to a surveillance system used in limited access environments.

### 2. Description of the Related Art

Limited access communities, such as apartment complexes, spend considerable sums each year relating to access. For example, repair costs for gates damaged due to cars running into them can average in excess of $40,000 per year for a typical gated apartment complex. Additionally, vehicle drivers who damage their vehicles as a result of improperly entering or exiting a gate sometimes claim that the damage resulted from a faulty gate.

Limited access communities also want to limit access only to authorized vehicles and they want to be able to provide security quickly within their boundaries.

Surveillance cameras are used by most apartment properties, yet many existing systems do little to deter or resolve events. Reasons for this include the fact that many properties are inadequately monitored. This can result in reckless behavior by tenants and visitors, damage to property and unsettled complaints by residents, which can lead to concessions being made by property managers, lease termination by dissatisfied residents and remarketing costs.

Therefore, there is a need for surveillance system that identifies vehicles entering and exiting limited access properties and that records events that it senses.

Therefore, there is also a need for a surveillance system that detects certain events, directs video cameras toward those events and that records sound and video of those events.

### SUMMARY OF THE INVENTION

The disadvantages of the prior art are overcome by the present invention which, in one aspect, is a surveillance system that includes at least one controllable first video camera having a field of vision. A sensor suite detects: an acoustic event, a direction to the acoustic event and a distance to the acoustic event, the sensor suite having a known spatial relationship to the first video camera. A processor is in communication with the first video camera and the sensor suite. The processor is programmed to aim the first video camera along in a direction indicated by the sensor suite when the sensor suite indicates that the acoustic event is consistent with predetermined criteria. A computer readable memory is in communication with the processor and stores video data from the first video camera and data from the sensor suite.

In another aspect, the invention is a limited access community security system for use in a limited access community having at least one access point. A video camera is disposed in a location so as to have the access point in view. A computer readable memory stores a database of stored license plate numbers. A processor is in communication with the video camera and that is programmed to: detect a detected license plate number of a vehicle that is in view of the video camera; compare the detected license plate number to the stored license plate numbers to determine if the detected license plate number is consistent with an unusual circumstance; and take a predetermined action when the detected license plate number is consistent with the unusual circumstance.

In another aspect, the invention is a thermal detection system. A wide angle reflector is mounted at an elevated position and is directed downwardly. A thermal camera is aimed at the wide angle reflector. A processor is in communication with the thermal camera and is programmed to generate a notification upon occurrence of a predetermined thermal event. The notification includes a location at which the predetermined thermal event has occurred.

In a representative example of one embodiment of a surveillance system for limited access properties, such as apartment complexes, gated communities, industrial sites and the like, the system includes at least one computer controlled camera (in one embodiment, two computer controlled cameras are used) mounted on a pole so as to be able to sense vehicles entering the property at, for example, a gate. The camera is configured to read the license plate of each entering vehicle. The data from the camera can be transferred wirelessly or via a hard wired line to a server, such as a server in a central office at the property.

The server performs a character recognition function on the license plate of each vehicle and stores the identifying character data. The server may also characterize the license plate by comparing it to a database of known license plates. This is a unique condition of a limited access property for a specific use. For example, the server can determine if the license plate belongs to a resident or an approved vendor (e.g., a plumber, electrician, package delivery vehicle, and the like) for quick entry into the property. The server can also determine if the vehicle belongs to a banned vehicle (e.g., an unapproved salesperson, a person under a restraining order, etc.) and alert security personnel or an interested resident when such a vehicle has been identified.

The video from the camera can be time stamped and stored by the server. This video can be useful, for example, in identifying vehicles responsible for gate damage upon entering or exiting the property.

The data from the cameras can be used for other purposes as well. For example, it can be used to detect when a second vehicle attempts to follow a cleared vehicle onto the premises. In such a case, if a gate comes down on a car, the video can be used for evidentiary purposes.

The video by itself or when coupled with a current sensor on the gate drive motor from the cameras can also be useful for identifying maintenance issues relating to the gate (e.g., jerkiness or other signs of wear).

The server can be employed to compare vendor invoices to records of vendor access to the property. For example, if an invoice charges for an electrician performing a service on a given date, the server can compare the invoiced date to the record of entering vehicles to determine if the electrician had actually entered the property on that date.

The server can also compare a partially read license plate to the database of known vendors and residents to complete identification of the license plate.

In another aspect, several computer controlled cameras with wireless communications capability can be placed at predetermined locations on the property. The cameras will have a remotely controlled pan/tilt/zoom capability. Directional microphones may also be employed.

In this aspect, the server can be programmed to detect certain types of noises (e.g., those associated with disturbances and accidents, screams, breaking glass, shots, and the like). When a predetermined noise is detected, the server will determine the source of the sound and direct the cameras so as to be able to record video at the place of the source. Both the audio and video can be recorded both for evidentiary purposes and current security purposes.

In one embodiment, the system can include an app for a smart phone so that certain people can interact with the system. For example, in an apartment complex, a resident can notify the system that its vehicle is entering the premises and cause the cameras to follow the resident's vehicle to the resident's apartment. Also, when the license plate reading device detects a resident vehicle entering the property the system can automatically communicate with the same residents smart phone application and instruct the phone, while on property, send its current location there by directing the cameras to view and record the phones current location to better monitor the residents. Also, this method prevents the phone from continuously using its GPS location service and thus substantially reduces battery drain for such a function. The app can also include a cluing mechanism indicating that the resident needs help from security, such as the smart phone being shaken or dropped. When such is detected, the system can notify security and inform a security officer of the location of the resident. The video and audio of the occurrence can also be stored for evidentiary purposes.

In another aspect of the invention, the recorded video can be stored with reference to the geographic area in view during the recording. The video and audio recordings are stored at the central computer with the geographic coordinates so that they may be retrieved by reference to a particular location on a map of the limited access property under surveillance. This greatly reduces the time needed to retrieve pertinent video evidence given that the moveable cameras can be self-directed to a particular view at any moment, such as by a pertinent audio event.

In another aspect, the surveillance system includes at least one field of view controllable camera. A plurality of human and object detection and relative position sensors use target position-related sensor data and target non-position related sensor data to prioritize the view of the controllable cameras when in a simultaneous multi-target environment.

In another aspect, the invention is a method of operating the surveillance system a set of coordinates is calculated and the coordinates are provided to a surveillance camera capable aiming and framing to the coordinates. The set of coordinates is employed to generate a consistent frame reference. The consistent frame reference is employed as a baseline in video analytics software.

In another aspect, the surveillance moveable camera can be controlled to generate a trigger output from a moveable camera that triggers when the moveable camera is physically moving. The moveable camera associated video analytics is started and stopped in response to the trigger output.

In yet another aspect, the video system includes a plurality of moveable cameras, each of the moveable cameras having a known camera position and video settings. At least one known visual target is disposed at a known position. A processor is configured to direct the moveable cameras and instruct the moveable cameras to capture data about the known target, and to analyze video data from the plurality of moveable cameras and compare the data from the cameras to expected data about the known target. The processor is also configured to adjust at least one of a video frame position and a video quality of at least one of the moveable cameras when the video data differs from the expected data.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is an elevational view schematic diagram showing one embodiment of a surveillance system.

FIG. 2A is a plan view schematic diagram showing a second embodiment of a surveillance system during normal operation.

FIG. 2B is a plan view schematic diagram of the embodiment shown in FIG. 2 in which the system is reacting to specific situations.

FIG. 3 is a perspective schematic view of an embodiment of a surveillance system that is tracking an individual.

FIG. 4 is a schematic diagram of an event sensing unit.

FIG. 5 is a schematic diagram showing topography.

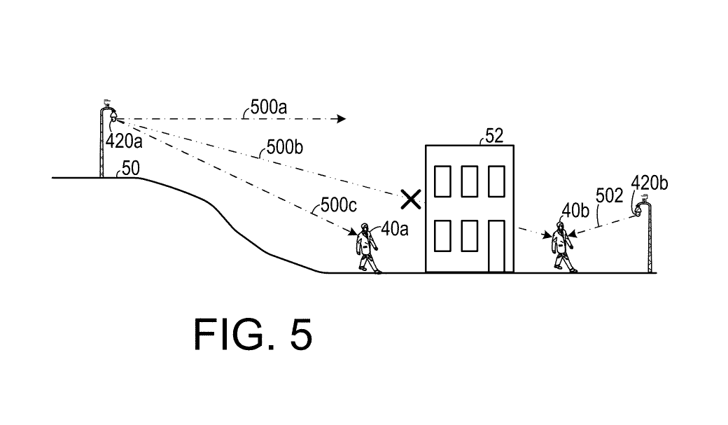

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

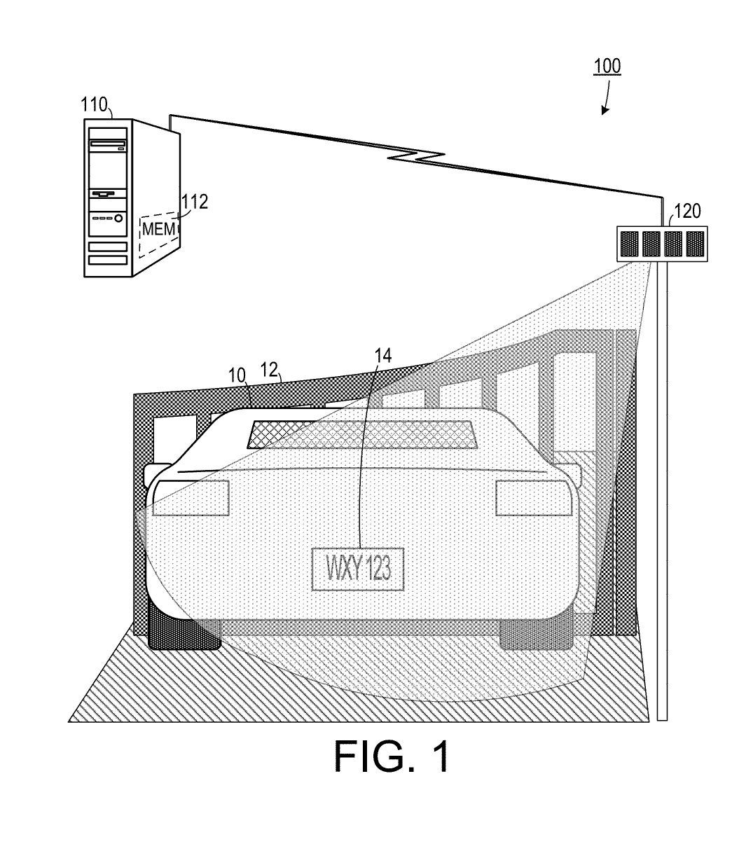

As shown in FIG. 1, one embodiment includes a controllable camera 120 in wireless communication with a server 110 (such as a server in a central office at the property) that is positioned at a limited access point 100 in the community and that is able to capture video of all vehicles 10 entering or exiting a limited access point (such as a gate 12) to a property. The camera 120 is capable of capturing an image of the vehicle's 10 license plate and the server 110 includes software that is capable of recognizing the text (e.g., the license number) on the license plate. The camera 120 is in wireless communication with the server 110 or in certain circumstances, it can be hard wired. Typically, each access point to the property (in cases where the property has multiple limited access points) would be in the field of view of at least one camera 120.

The processor of the server 110 is programmed to: detect the license plate number 14 of a vehicle 10 that is in view of the video camera 120; compare the detected license plate number 14 to a list of known license plate numbers that are stored in memory 112 to determine if a detected license plate number 14 is consistent with an unusual circumstance and take a predetermined action when the detected license plate number is consistent with the unusual circumstance. Examples of such unusual circumstances can include: the vehicle belongs to someone who has been put on a watch list (which could include a person who has been put on the watch list as a result of a request by a tenant), or has been restricted from the property; the vehicle is not on a list of authorized vehicles (such as a list of tenants or known vendors that are authorized by the community management); the vehicle is the subject of a police-generated alert; etc. The action could correspond to a classification associated with the license plate number. For example, if the license plate number is classified as “unrecognized,” “watch list” or “banned” then security personnel could be notified. If the number has been placed on a watch list as a result of a tenant request, then the system could notify the tenant of the vehicle's presence.

Once the text on the license plate is recognized, it is associated with the video, which is also time stamped and stored in a computer readable memory 112 associated with the server 110. This video can subsequently be used for evidentiary purposes, such as demonstrating that contact with the gate 12 by a vehicle caused damage to the gate 12. It can also be used to detect gate malfunction, which could be due to other causes.

The server 110 can compare the license number of a vehicle to a database and then take an appropriate action. In one example, the server can detect when an unauthorized vehicle has entered the property, such as a vehicle owned by someone under a restraining order. When such a vehicle is detected, the server 110 can notify security personnel. Also, an interested party, such as the person protected by a restraining order, can be notified by the server 110 whenever such a vehicle has entered the property. In one example, a resident can request to be notified (e.g., via a cellular telephone message) whenever a certain vehicle enters the property. However, in an apartment complex environment, the server can also prohibit a resident from being notified when another resident enters the property to prevent one resident from stalking another resident by using the system.

The license plate numbers can also be associated with a “time in” time stamp and a “time out” time stamp. This information can be used as part of an audit trail that can be associated with contractor invoices. For example, an electrician's vehicle can be logged in an out automatically and the login/logout times can be compared to charges on the electrician's invoice to determine if the charge was correct.

The server 110 can maintain a database of residents, authorized service vehicles (such as vendors), known delivery vehicles and guests. The sever 110 can automatically authorize entry of certain vehicles, such as those belonging to residents and authorized service vehicles and can also enhance surveillance for certain vehicles, such as those belonging to guests.

In one embodiment, the video can be coupled with data regarding the amount of current that is drawn by the gate motor each time the gate opens. An abnormal current draw could indicate either a jammed gate or tampering. The server 110 can alert appropriate personnel of the abnormal current draw. The alerted person can view the video to determine if the gate is malfunctioning or if someone is treating the gate improperly (e.g., stopping the gate or attempting to force entry). With an audio direction finding device the system can be programmed to view only the audio source from a pertinent direction with in the surveilled limited access property.

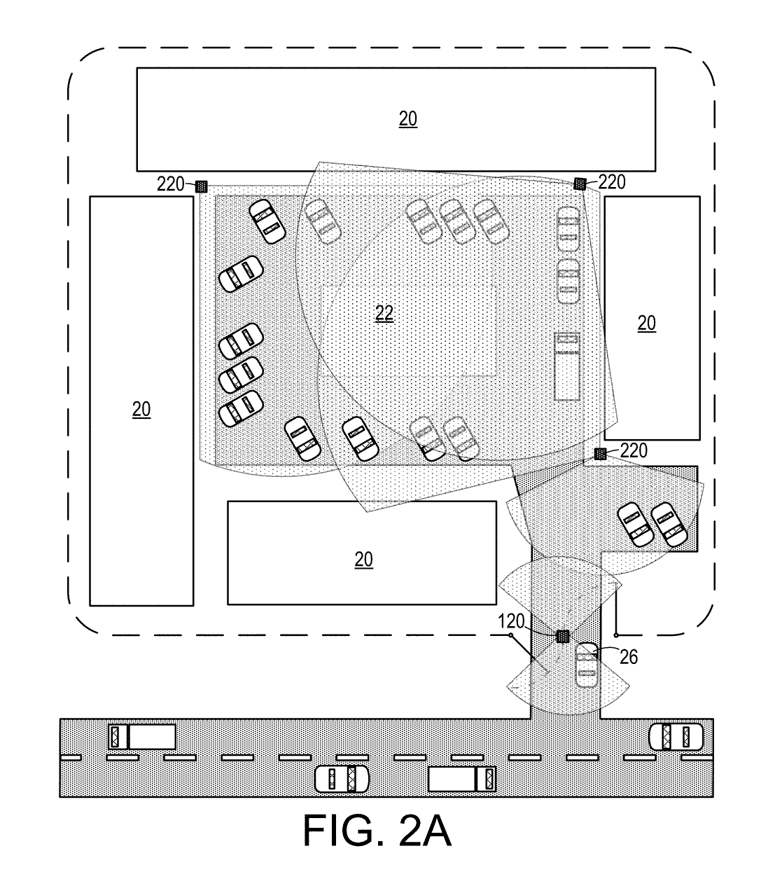

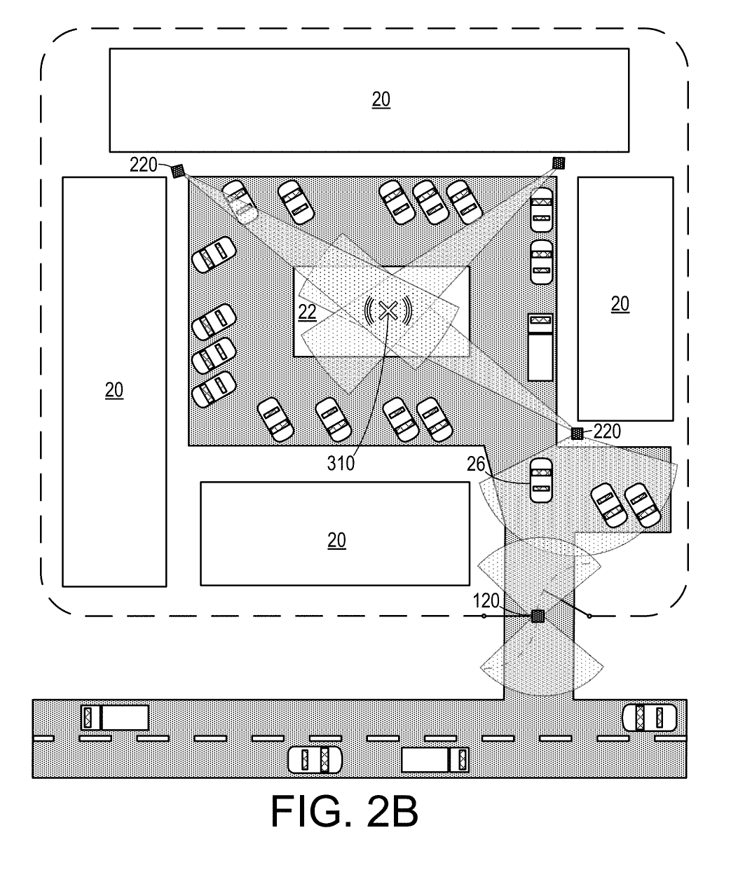

As shown in FIGS. 2A-2B, a plurality of camera/audio receiver units 220 can be dispersed about the property. Typically, the camera/audio receiver units 220 will include remotely controllable pan/tilt/zoom cameras that can be adjusted by signals received from the server 110. The camera/audio receiver units 220 will also include directional microphones that are able to determine the direction of a sound.

By dispersing several camera/audio receiver units 220 throughout the property, the system can track various items throughout the property. For example, car 26 is shown entering the property in FIG. 2A, but it is tracked after entering the property, as shown in FIG. 2B.

The server 110 is programmed to detect specific sounds through noise signature analysis and take appropriate action when such a sound is detected. For example, if it detects the sound of breaking glass, the server can triangulate on the source of the sound and direct the cameras to that source to record video for evidentiary purposes. The server can also alert security personnel to go to the source of the sound.

As shown in FIG. 2B, for example, a sound is detected at point 310. The server 110 determines the location of point 310 by triangulating the radial directions sensed by three of the directional microphones and compares the sound to its database and determines that the sound is of the type associated with an altercation. The server 110 then directs cameras in the camera/audio receiver units 220 to zoom in on the point 310 and record video from different directions. The server 110 can also notify security and supply real time video of the altercation to the security personnel.

The system can also be used to detect high volume noises. For example, if a tenant plays loud music at inappropriate times, the system can locate the source of the noise and record incidents of such loud music. This can be used as evidence in tenant disputes and eviction proceedings. It can also be used to alert security personnel to intervene.

This system can also be configured to detect sounds from predetermined locations. For example, at an apartment complex, the system can be configured to detect noise coming from a swimming pool area when the pool is closed. This can be used to notify the property manager and security personnel of unauthorized entry to the pool. The cameras can be directed to the pool to record video of the people in the pool and the video can be stored and time stamped for use by the property manager.

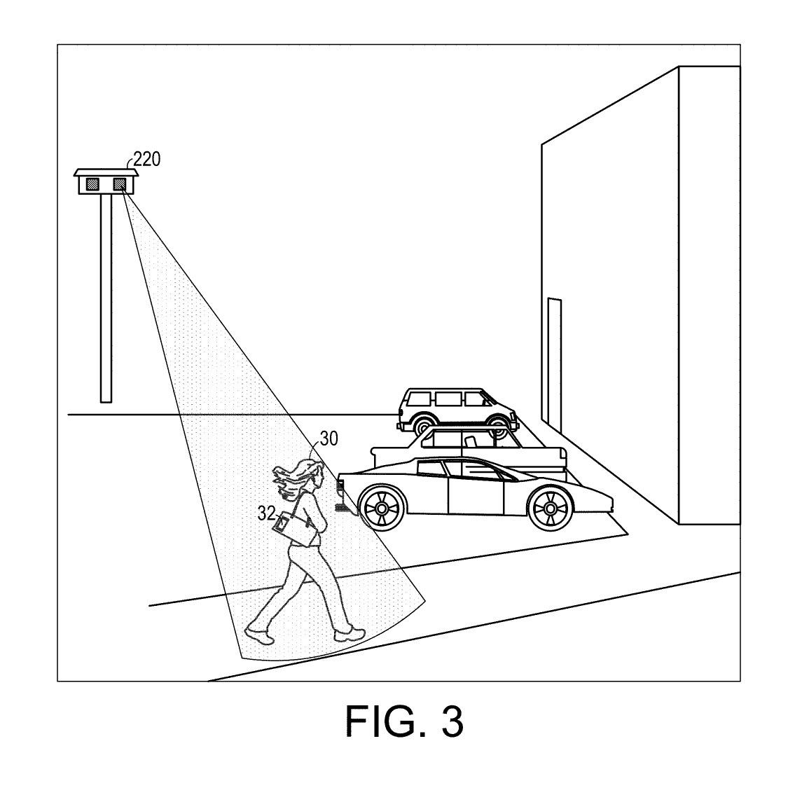

As shown in FIG. 3, the system can also respond to a tracking request by an individual. This tracking request can be automatically initiated by the system by detecting the entry of a resident by license plate reading and then instructing the corresponding resident's cell phone to send its current coordinates to the system. Also, since the resident apartment address and location may be known to the system this tracking function can be automatically stopped when the resident arrives at their apartment. For example, a tenant 30 at an apartment complex can request that her location be monitored by a camera/audio receiver unit 220 as she walks from her car to her apartment. The system will receive location data from her cell phone 32 (which would be running a cell phone application associated with the system) and a camera/audio receiver unit 220 will aim at the location of her cell phone 32 while she is walking to her apartment. If she indicates alarm, such as by shaking or dropping her cell phone 32 (which could be sensed from accelerometer data received from the cell phone 32), or pressing a button on the cell phone 32 (or through another triggering event), security can be notified of a possible altercation. Video data from the camera/audio receiver unit 220 can even be fed back to the cell phone 32, which could act as a deterrent when a tenant 30 shows the real time video to a potential assailant. Once the tenant 30 arrives safely at the location of her apartment (or other predetermined location), the system can cease tracking the cell phone 32 and reassign the camera/audio receiver unit 220. Also, the processor can receive and store video data from the camera(s) on the cell phone 32.

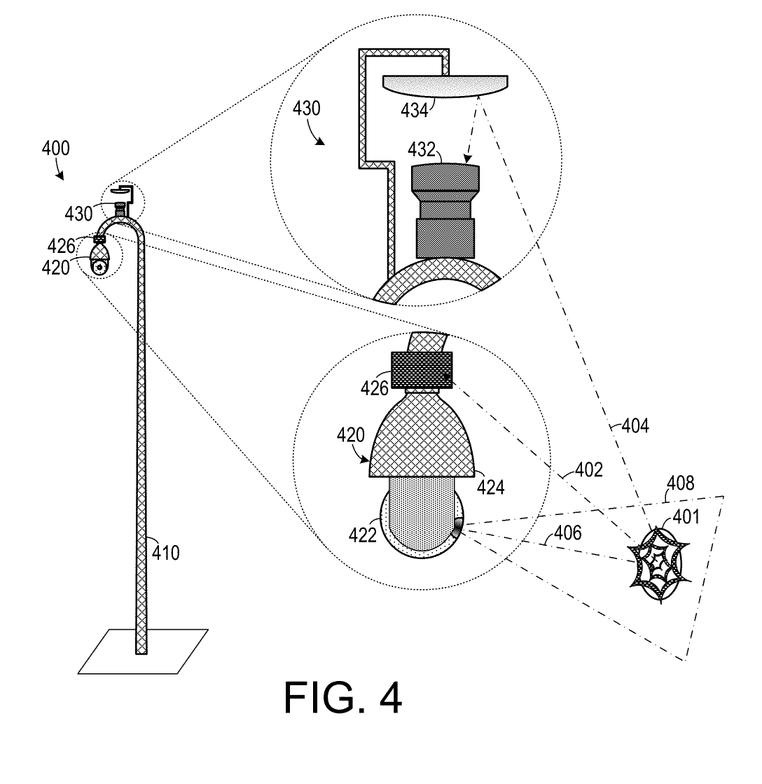

As shown in FIG. 4, in one embodiment, a direction/elevation/focus controllable video camera 420 and a sensor suite 400 can be mounted on a pole 410 (although, different sensors in the sensor suite 400 can be located at different locations). The sensor suite 400 can include a directional acoustic sensor 426 (or other type of geographically-aware event indicating device), such as a directional microphone, and an object sensor 430. The object sensor 430 can include a wide angle thermal sensor, which could include a thermal camera 432 that is aimed at a 360° wide angle reflector 434 (reflectors that cover less than 360° can be employed in certain situations, such as when mounted on a wall). All of these devices are in communication with the processor, which would be accomplished through a wireless connection or could be hard wired. The thermal sensor could also include a thermal camera with an extremely wide-angle lens (e.g. a “fisheye” lens). The video camera 420 can include a laterally rotatable mount 424 that holds a vertically rotatable camera unit 422.

Other types of object sensors could be employed to sense the distance and direction of an object 401, such as a second video camera aimed at a wide angle reflector 434, an ultra-sound detector, a radar detector, etc. In certain circumstances, thermal sensors may have difficulty distinguishing an object from its background, such as when the temperature of the object is close to the ambient temperature. In these situations, use of alternate sensor types can be used to locate the object. Such additional sensors can include video cameras, ultra sound sensors, radar sensors, etc.

In operation, when an object 401 generates a sound that is characteristic of certain criteria (such as the sound of glass breaking, the sound of an altercation—such as a verbal altercation, the sound of a vehicle accident, the sound of a gunshot, a sound that is louder than a baseline loudness by a predetermined threshold associated with a given location and time period—which could indicate a loud party, etc.), the directional acoustic sensor 426 will sense the sound 402 and then transmit the sound and a radial direction (bearing) from the microphone 426 to the source 401 of the sound event to the processor, which analyzes the sound to determine if it is consistent with the criteria and stores the direction to the sound. The thermal camera 432 will also sense a thermal image 404 of the object 401 causing the event and the processor will analyze the data from the thermal camera 432 to determine a range to the object. The processor will then direct the camera 420 to aim, zoom in on the object 401 (by setting a zoom factor, based on the distance to the object 401, that would cause the camera's field of vision to be nearly filled by the image of the object 401) and focus on it. If the object 401 moves, the processor will direct the camera 420 to track the object and will record all of the video data, sound data, thermal data and other data (if available) relating to the event and the object. The processor will calculate the spatial coordinates of spatial volume within the camera's field of view 408 and store the spatial coordinates, the video/sound/thermal data and a time/date stamp associated with the video. This data can be retrieved at a later time and used, for example, as evidence.

Data from the thermal camera 432 can be used to detect thermal anomalies associated with a property. For example, it could be used to detect the early stages of a fire by detecting a rapid heat increase through a window. If a fire is detected, the property manager can be alerted by the processor through an alarm and the fire department can be alerted. The video camera 422 can be aimed at the source of the fire. Similarly, the system can detect an abnormal hot spot in a wall, which could be an early indicator of a fault in an electrical distribution system.

As shown in FIG. 4, the system can be used in areas of varying topography (such as in the presence of hills 50) and in areas with known vertical obstructions (such as buildings 52). When a camera 420a is at an elevation that is different from that of the object 40 of interest, merely pointing the camera at the radial direction (as shown in beam 500a) would not result in the object 40a being seen by the camera. Similarly, if the object 40b is behind an obstruction 52, the obstruction 52 would block the view 500b of the camera 420a. Therefore, the processor memory stores a map of the topography and known fixed obstructions in the area of the camera 420a. Based on the information stored in the map, the processor will set an elevation (or tilt) angle and a zoom factor so that the object 40a will be in view 500c. When the processor determines that the view 500b of a given camera 420 would be blocked by an obstruction 52, it can determine if an alternate camera 420b will have an unobstructed view 502 of the object 40b. In the case shown, items 40a and 40b can represent one object at different times, such as when a person walks behind a building.

Once representative commercial embodiment can include an audio and video surveillance system for limited access properties with known residents. Limited access allows one to determine who is on property and who is off property by having license plate reading at every entrance and exit. Since these are residential properties where identification of the residents, employees and registered vendors are known, certain unknowns can be detected very easily. The system can also “learn” who are frequent guests and further reduce search for unknowns.

This embodiment can provide license plate reading for limited access (apartment) properties with known residents for the purpose of documenting vendor on premise time to use as an accounting check for vendor invoices. Using vendor transits via license plate reading results can enable the system to tie monthly invoices to “on property” visits. Specifically, for vehicle based services such as security patrols, landscaping or other services. This can be used as part of a vendor audit system.

The embodiment can include an alarm system using license plate reading. Because the system maintains a database of known residents and license plates, it allows residents to enter alerts. For example, a resident can request a text notifying that a specific individual has just entered the property, such as when someone subjected to restraining order protecting a resident has entered the property. Such an alert could be based on a license plate number. In one embodiment, residents would not be allowed to enter alerts for other residents of the same property, so as to prevent one resident from knowing when another resident is present or absent (which would prevent using the system for harassment or as an alerting tool for criminal activity).

A self-correcting license plate reading system can be included to compare license plate reads to a list of known resident plates. The system could employ neural or fuzzy logic systems to determine license plate numbers when a corresponding license plate does not exactly match any known license plate or when the camera's view of a license plate is partially obstructed. If such a match is found, then the system can auto correct the number using OCR (optical character reading software) neural network software to learn to read certain characters better next time.

One embodiment, the system can detect, identify and report wrong way travel through a gate. Using directional motion detection (pixel analysis) of a fixed camera viewing a road that has a known direction of travel (such as an entrance gate or an exit gate) the system can determine if a vehicle is improperly entering via an exit route. Using this detection with a license plate reading camera for documentation and a system that is in communications with the internet would enable the system to instantly communicate the improper entry to property authorities with identification of the offending vehicle.

One embodiment includes a system for detecting mechanical trouble or damage to traffic gates. Most entrance gates are powered by AC electric motors. By using current sensors, the system can monitor the entrance/exit gate motors current (watts) usage patterns. When a gate has mechanical difficulties (jerking, pulling, stuck) the current use pattern will fluctuate due to varying torque. The system detects these variations and via an internet link can communicate these pattern variations to property personnel as a warning of potential gate malfunction. In addition, should a vehicle hit the gate during operation an abnormal current use pattern should be produced thus setting off a notification. This information could be coupled to video for detecting and reporting gate faults and the possible causes thereof.

In one embodiment, a wide area alarm system uses moveable cameras and cell phones with GPS circuitry. Information from the cameras and cell phone can be communicated to a central computer indicating the cell phone location. The central computer can analyze the location and determine if the location is within visual view of a moveable video camera (whose location is known to the central computer) and then command the moveable camera to view and record the location of the reporting cell phone. The system can also include a function by which the cell phone owner can initiate an alarm to the central computer such as using the cell phones built in accelerometer to detect if the cell phone is dropped or shaken strenuously. This duress alarm would command the central computer to direct other moveable cameras in the area to view the location of the cell phone. Additionally, if the system where located in a plurality of properties, and if such plurality of systems are in communication with each other, then the residents of one property could use the system of another property to expand the effectiveness of the duress alarm feature.

In one embodiment, the system maps a moveable camera with a known location and with a zoom lens to equate to recording, storing and retrieving video by definition of geographic volume of space. The three dimensional volume of space can be defined as a longitude, a latitude and elevation. The central computer could have a graphic user interface that utilized maps of the area of surveillance to allow retrieval of video from movable cameras by reference to an area.

One embodiment includes a method for storing, searching, retrieving and displaying audio and video surveillance data. This embodiment can include a plurality of moveable cameras and a central computer in communication with the cameras that receives video from the cameras and analyzes the video to add, in addition to time of the video, other analyzed identifiers of the video in a database so searches of the video could be done by the other database identifiers.

One embodiment includes a method and apparatus for detecting an event or a human presence for the purpose of directing a moveable video surveillance camera. The system can combine a moveable camera that can be controlled to an absolute position of view with a plurality of event sensing sensors that can command the camera to move to view the detected event.

One embodiment includes at least one thermal sensor to detect objects and events and their direction from a controllable, moveable video surveillance camera. This embodiment combines a controllable moving camera, a thermal camera, a computer performing pixel analysis of the thermal camera and conical reflector enabling a horizontal 360° field of view. The combination results in a device that senses thermal energy in a 360° view and commands the controllable moving camera to view and record the area of the thermal energy source.

One embodiment includes an audio surveillance and alarm system for multi-family properties. This embodiment employs a plurality of audio direction finding and recording devices in known geographic locations that are in communication with a central recording computer. The system can record and track the decibel level and direction of audio events. The system can also alert property authorities if certain audio events exceed standard historical limits or preprogrammed limits. The system uses the direction of the audio event and recording to ascertain the apartment that the audio event came from.

One embodiment includes a method and apparatus for recording, documenting and evaluating human work performance. The system can include a cell phone with data transmission capability, GPS, video recorder, an accelerometer and a central computer system. Upon activation, the system can continuously record the cell phones accelerometer readings for the purpose of assessing work effort from all three axes. The system can also use the cell phone's GPS to occasionally record the phones location. When employees finish a task they evoke an application on the cell phone and record via written text, photos, audio recording or video recording an account of their work. This recording is associated with the employee's work orders on the property.

In one embodiment, the system includes a plurality of audio direction finding and recording devices in known geographic locations that are in communication with a central recording computer. The audio direction finding devices send audio recordings and its respective source direction to the central computer. The system is programmed with the geographic location of buildings and the apartments within those buildings. The system records and tracks the decibel level and direction of audio events. The system also stores a database of average audio events decibel level and direction so that it can determine, in real time, if a current audio event is within normal (or preprogrammed) decibel levels. The system can alert property authorities if certain audio events exceed standard historical limits or preprogrammed limits. The system can use the direction of the audio event and recording to ascertain the apartment that the audio event came from. The system can be used in combination with controllable moveable video cameras that can be used to video record the audio event given the direction of the audio event. Audio events can be recorded locally at the audio recording device and sent as a non-real time file to the central computer thus assuring the integrity of the audio recording. Audio events can also be analyzed at the central computer for audio signatures such as human voice, words spoken, car alarms, gunshots and the like, and if certain audio signatures are determined the central computer can notify property officials.

In one embodiment, the system will detect background noise over time (such as the sound of a nearby road) and mask noise sounds from its recording of audio. The system can also be programmed to learn which areas to which a camera is most frequently directed and then point the camera at such an area when not engaged in other activity. In some embodiments, the processor will engage in video analytics (e.g., detecting forms of a person or another object and storing detected form data with the video data). Typically, when a camera is moving from being directed to one location to another location, the video would appear as a blur and a video analytic system would perceive the video as showing motion. The system can programmed in such situations to cause video analytics to cease when movement commands are being sent to a camera and to recommence analytics once the camera has stopped moving.

One embodiment employs a passive infrared motion detector to direct a moveable camera to view the area of motion detected by the passive infrared detector. In another embodiment, a plurality of passive infrared detectors are used in conjunction with a moveable video camera. Each passive infrared detector has a specific and different field of view of motion around it and the collocated visual spectrum video camera.

Several fixed passive infrared detectors each has a different field of view and the system can direct a moveable visual and infrared illuminated spectrum video surveillance camera to record the field of view from a particular passive infrared detector that has detected motion. The result is that a single moveable camera can be made to surveil for motion or human presence an area wider than the visual spectrums camera lens. Therefore, a single camera can perform the surveillance work of multiple fixed cameras. Additionally, the detection of motion or human presence by a particular passive infrared detector can generate a signal to a guard or recording device that indicates motion was detected, thus prompting further actions.

Additionally, the system can use of a predetermined tilt angle for a specific field of view for the moveable camera. When the passive infrared detector senses motion or human presence, the moveable camera is turned to the same field of view. The moveable camera is also adjusted to tilt up or down given the nature of local terrain around the position of the moveable camera so as to frame the potential target correctly within the field of view of the moveable camera, thereby obtaining a better image of the target.

In using video analytics with moving pan/tilt/zoom video surveillance cameras, the video recorder or video analytic software, may not know when the camera is in a transition from one field of view to another. The video from the camera during this repositioning movement is interpreted as motion itself, which can be improperly analyzed. Therefore, one embodiment instructs video recorders or analytic software routines not to analyze the portion of the video stream generated while the moveable camera is repositioning itself or the cameras field of view.

When using a local Bluetooth transmitter to continuously transmit GPS correction data to a local smart phone, the system can combine blue tooth beacons. Bluetooth beacons can be used as VORs (vertical omni range). Phase array Blue tooth receivers can be used for determining a transmitter vector from receiver. A Bluetooth beacon can be collocated on a self-directed camera post to broadcast its presence to a smart phone equipped with an application programmed to listen for the presence of a self-directed camera. This is for the purpose of automatically powering up the smart phone location services and transmitting the smart phone location so that the geographically aware self-directed camera can move its field of view to the smart phone and thus video record the smart phone and area around it and also potentially respond to smart phone user inputs (shaking/dropping the phone) that indicate duress from the smart phone user.

Screen indicators to the surveillance system operators can indicate of out of view audio and thermal activity for manual operators to evaluate. The system can use data from an accelerometer can cause a camera direction of view and tamper warning message. The system can use a magnetometer with a collocated movable camera, that has a known latitude/longitude, to determine the cameras true north center of view so as to be able to view a remote target of a known latitude/longitude coordinate

Camera Director Logic and Hierarchy of Priority

A suite of human presence sensors of divergent sensing capabilities (such as noise signals, thermal signals, radar signals) can be used to feed simultaneously computer controlled moveable camera human activity target data so that the moveable camera may view, record and report such human activity. This task involves prioritization of simultaneous or geographically diverse multiple targets reported by the sensor suite to the controlling computer. Therefore, the system employs hardware and software to prioritize and economize the moveable cameras field of view and the systems actions at any given moment given the sensor suites target data at that moment. One embodiment employs a neural network to analyze and determine normal activities within the field of view of a collocated human presence sensor suite and moveable camera to help direct the moveable camera to identify, view, record and report abnormal activities.

The target activity memory around a self-directed surveillance camera can be used to prioritize the self-directed cameras view to the newest or most pertinent activity given the purpose of prioritizing the cameras limited field of view when the collocated human activity sensor suite detects multiple simultaneous human or other activities in which each activity being geographically impossible to view simultaneously with the single moveable video camera.

The combination of disparate human presence sensor technologies provides not only a uniquely reliable presence location data in which to turn one or more moveable/controllable surveillance cameras, but also offers the sensor controlling computer with multiple decision data inputs about which targets to turn to, dwell on, and for how long.

For example, if multiple targets are detected by any one of the sensors at the same time, the target non-position related data can help determine which target to view and record first. For example, volume level, size of target, target velocity, target direction of travel, target temperature can be used. Any of these non-position related data points can help the controlling computer decide where to point the surveillance camera and how long to dwell there before re-tasking to another target outside (or inside) the field of view of the surveillance camera.

Combining an audio direction/sound analyzer finder with other direction finder technologies, such as thermal and microware radar, results in a unique outcome of the pairing in identifying which target to look at during occurrences of multiple targets. Humans and unwanted events tend to have certain noises associated with them. Such noise gives an azimuth but not a distance as many times two audio direction finding receivers will not detect or recognize the audio as the same event sufficiently to provide triangulation. Thermal and microwave direction finders give accurate azimuth and distance to target information but lack information to prioritize, and focus on, which of many targets detected.

The addition of software that tracks new targets versus older targets can improve self-directed the outdoor audio/video safety system, which attempts to record as much pertinent information as possible of unfolding events. Simply watching the loudest event may not reveal all that is happening. Ensuring the recording of new participants, witnesses or events can be important. Thus, detecting by area, determining by time, and tracking new objects and target quality data is an important aspect of the system.

One embodiment determines and classifies activity in a known area as normal or abnormal, primarily for the purpose of focusing a surveillance camera on the activity instead of other activity and classifying such video recording as being abnormal and thus alerting a remote system or a person to further analyze the abnormal activity for possible proactive response actions.

For example, if a surveillance camera equipped with human activity sensor(s) and a collocated or remote controlling computer was at a fixed location, then the controlling computer could record and store activity of the surveilled area such as the location where targets appeared, the direction and velocity they moved, whether or not they stopped, and if so where. Then the controlling computer could classify the appearance, velocity, and direction of movement that was statistically different as abnormal activity. The system then could instantly begin to record and report such abnormal activity. In another example, when a vehicle is detected at traveling at an abnormal speed or direction in the surveilled area, or a person running in a surveilled area, or a person yelling in the area can result in recordation of the event. Several other variables can be used to classify abnormalities, such as time of day and day of week.

When using a single controllable surveillance camera to view and record a wide area, often there are multiple, simultaneous events occurring within the surveilled area of the camera(s). There can be a problem directing the camera(s) to view and record the most pertinent events occurring during the moment. Acoustically directed cameras often only view the loudest current noise, Radar directed cameras often can only sequentially view and record targets as they are presented to the area sensor(s) in the order they appeared. These systems for directing a controllable surveillance camera many times could direct the camera to view/record less important events at any given moment. Therefore, the system includes a mechanism to determine the most significant and important event in a surveilled area given any moment in time above and beyond simple position.

The system can direct a controllable surveillance camera to view/record what appears to be the most significant current event in the surveilled area. Some existing computers have the ability to interpret the spoken word into written language and to determine the acoustic direction and signature of a gunshot. Also, radar or thermal sensors are able to determine the direction, size, velocity and direction of movement of physical targets. Certain combinations of these detection and prioritization technologies with a controllable surveillance camera(s) allows for prioritizing, viewing, recording and potentially reacting to normal events that become abnormal physical or human events for evidentiary or response purposes.

Such combinations can include:
The determination of the direction of a gunshot to turn associated controllable camera(s) to view, record and respond to said gunshot.
The determination of various spoken words that indicate abnormal or unwanted human events coupled with the direction of such words to direct a controllable surveillance camera to view, record and respond. Examples of such words include: “help,” “stop,” “no,” “don't,” and the like.
The determination of voice duress in a spoken word(s) coupled with the direction of such spoken words to direct a controllable camera(s) toward viewing, recording and reacting in a plurality of ways too such duress. Duress can be replaced with other determinations such as excitement, sadness, happiness of other human emotions projected through verbal communications.
The determination of abnormal physical actions in a surveilled area such as location, direction of travel, velocity or size of presence to direct a controllable camera(s) to view, record and react to, in a plurality of ways, such events. Another such abnormal event might be the convergence of two separate objects into what appears to presence sensor, a single larger object thus indicating to the system the objects are now in physical contact with each other and therefore, possibly, creating physical damage.
The determination of a moving targets proximity to another fixed or mobile location. Other location(s) may be pre-programmed or posthumously defined location(s).

In a self-directed camera system, the camera directing sensors determine the direction of view and, when distance to target can be determined, the appropriate zoom level to frame the target correctly for best resolution. Given this typical video analytics for determining such things as counting people, vehicles, objects in frame is problematic due to inconsistent camera field of views. Two ways to address this problem include: 1) the camera director system can record exact camera field of view settings of previous targets and adjust a current target setting to match the previous views settings so past and present frames can be compared and analyzed; or 2) the self-directed camera can be programmed to occasionally (on a set semi schedule frequency) to go to preset or otherwise determined field of view settings of known values to record video to be analyzed. Since past and present analyzed frames would be of the same settings they would be analyzing the same geographic areas for content.

When using video analytics with moving pan/tilt/zoom video surveillance cameras, the video recorder or video analytic software may not know when the camera is in a transition from one field of view to another. The video from the camera during this repositioning movement is interpreted as motion itself and therefore improperly analyzed. Therefore, the moveable surveillance video camera, or its operator, informs video recorders or analytic software routines not to analyze the portion of the video stream generated while the moveable camera is repositioning itself or the cameras field of view.

In an automated, self-guided surveillance system that has the capabilities for aiming and framing and target solely by the means of geographic coordinates, it is important that the system can test this ability to ensure the electrical position sensing and mechanical movement devices have not worn or failed as this would lead the system to “look” in the wrong place and thus not video the desired target. Therefore, the system employs a self-test function to ensure the camera system has the ability to move, zoom, focus and video a known entity and test for known video results to ensure system functionality.

In one embodiment, a geographically aware camera is controlled to move to predetermined field of view and then use video analytics to find a known target in a known frame location, which can be performed on demand or at prescheduled times. This ensures that the commands used to position a video camera result in the moveable camera achieving the correct anticipated position and video settings to identify the known target. If any of the camera movement mechanics and electronics are not functioning as expected, then the resultant video frame would not have the known target in the correct frame position of expected coloration or focus. Therefore, the video system relies on the ability of its cameras to be commanded to look at a geographic location at an unknown target can be tested for accuracy of task.

This self-test/correction routine can include:
Directing a camera to a known target, in known position, known lighting, known colors and shape’
On a known schedule point, set a moving camera at known target and then analyze the video to find and evaluate the known target visual values;
If known target is not found then begin a process of moving camera position and settings to try and locate known target. If found then attempt to self-correct movement and camera settings to continue operation within known position and video quality parameters;
If the system cannot find target, or if target video quality values are less than allowed the system can create a remote system alarm notification for service to device;
Permanently mount a visual test target of known visual values given a certain camera's settings at a known location;
The test target does not have to be on camera mount. The test target could be placed at a distance from the moving camera and the unique position and camera visual settings for a specific camera can be set for accuracy tests for the camera.

In one commercial embodiment, the surveillance system includes at least one field of view controllable camera. A plurality of human and object detection and relative position sensors use target position-related sensor data and target non-position related sensor data to prioritize the view of the controllable cameras when in a simultaneous multi-target environment. The target non-position related sensor data can include a temperature of the target. The target non-position related sensor data can include a velocity of travel of the target. The target non-position related sensor data can include a measured vector of travel of the target. The system can be configured to compare the vector of travel of a first target to the vector of travel of a second target and to determine a current proximity between the first target and the second target, a predicted proximity between the first target and the second target, and a divergence of proximity between the first target and the second target.

Also, the target non-position related sensor data can include a time that the target was detected. The target non-position related sensor data is compared to a preprogrammed set of position or non-position related data to determine a target priority. The position related sensor data and the non-position related sensor data of a target is compared in near real-time to a plurality of historical target data sets to determine a normality of a current target data set in comparison to historical data sets of target qualities. As a result, normality determination is used to invoke an action.

In operating the surveillance system, a set of coordinates is calculated and the coordinates are provided to a surveillance camera capable aiming and framing to the coordinates. The set of coordinates is employed to generate a consistent frame reference. The consistent frame reference is employed as a baseline in video analytics software. The set of coordinates can include: geographic coordinates; coordinates from a previous camera view and coordinates from a predetermined Cartesian grid system around the surveillance camera.

The surveillance moveable camera can be controlled to generate a trigger output from a moveable camera that triggers when the moveable camera is physically moving. The moveable camera associated video analytics is started and stopped in response to the trigger output. The trigger output starts and stops at least one of a video stream of the moveable camera and video analytics of the video stream of the moveable camera.

The video system includes a plurality of moveable cameras, each of the moveable cameras having a known camera position and video settings. At least one known visual target is disposed at a known position. A processor is configured to direct the moveable cameras and instruct the moveable cameras to capture data about the known target, and to analyze video data from the plurality of moveable cameras and compare the data from the cameras to expected data about the known target. The processor is also configured to adjust at least one of a video frame position and a video quality of at least one of the moveable cameras when the video data differs from the expected data. The known target can be affixed to a mounting pole on which a moveable video camera is mounted or it can be affixed to a known partner camera pole in a known position and known geographic position.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A surveillance system, comprising:
(a) at least one field of view controllable camera; and
(b) a plurality of human and object detection and relative position sensors that use target position-related sensor data and target non-position related sensor data to prioritize the view of the controllable cameras when in a simultaneous multi-target environment.

2. The system of claim 1, wherein the target non-position related sensor data comprises a temperature of the target.

3. The system of claim 1, wherein the target non-position related sensor data comprises a velocity of travel of the target.

4. The system of claim 1, wherein the target non-position related sensor data comprises a measured vector of travel of the target.

5. The system of claim 4, wherein the system is configured to compare the vector of travel of a first target to the vector of travel of a second target and to determine a current proximity between the first target and the second target, a predicted proximity between the first target and the second target, and a divergence of proximity between the first target and the second target.

6. The system of claim 1, wherein the target non-position related sensor data includes a time that the target was detected.

7. The system of claim 1, wherein the target non-position related sensor data is compared to a preprogrammed set of position or non-position related data to determine a target priority.

8. The system of claim 1, wherein the position related sensor data and the non-position related sensor data of a target is compared in near real-time to a plurality of historical target data sets to determine a normality of a current target data set in comparison to historical data sets of target qualities.

9. The system of claim 8, wherein a normality determination is used to invoke an action.

10. A method of operating a surveillance system, comprising the steps of:
(a) calculating a set of coordinates and providing the coordinates to a surveillance camera capable aiming and framing to said coordinates; and
(b) employing the set of coordinates to generate a consistent frame reference;
(c) employing the consistent frame reference as a baseline in video analytics software.

11. The method of claim 10, wherein the set of coordinates includes geographic coordinates.

12. The method of claim 10, wherein said coordinates includes coordinates from a previous camera view.

13. The method of claim 10, wherein said coordinates includes coordinates from a predetermined Cartesian grid system around the surveillance camera.

14. A method of controlling a surveillance moveable camera, comprising the steps of:
(a) generating a trigger output from a moveable camera that triggers when the moveable camera is physically moving; and
(b) starting and stopping the moveable camera associated video analytics in response to the trigger output.

15. The method of claim 1410, wherein said trigger output starts and stops at least one of a video stream of the moveable camera and video analytics of the video stream of the moveable camera.

16. A video system, comprising
(a) a plurality of moveable cameras, each of the moveable cameras having a known camera position and video settings;
(b) at least one known visual target at a known position; and
(c) a processor that is configured to direct the moveable cameras and instruct the moveable cameras to capture data about the known target, and to analyze video data from the plurality of moveable cameras and compare the data from the cameras to expected data about the known target, the processor also being configured to adjust at least one of a video frame position and a video quality of at least one of the moveable cameras when the video data differs from the expected data.

17. The video system of claim 16, wherein the known target is affixed to a mounting pole on which a moveable video camera is mounted.

18. The video system of claim 16, wherein the known target is affixed to a known partner camera pole in a known position and known geographic position.
